(19) United States
(12) Patent Application Publication
(10) Pub. No.: US 2005/0200319 A1
(43) Pub. Date: Sep. 15, 2005

(54) Image display apparatus, drive method for the image display apparatus, and television set

(75) Inventors: Akihiko Yamano, Kanagawa-ken (JP); Takahiro Oguchi, Kanagawa-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/068,837

(22) Filed: Mar. 2, 2005

(30) Foreign Application Priority Data
Mar. 9, 2004 (JP) 2004-066103

(51) Int. Cl. G09G 1/04

(52) U.S. Cl. 315/382.1; 315/382

(57) ABSTRACT

In order to provide high-quality image display by correcting and uniformizing the nonuniformity of electron emission characteristics, a predetermined arithmetic operation is performed by using correction values for correcting the nonuniformities of luminance caused by the electron emission devices when a predetermined voltage is applied thereto, thereby calculating correction values when the voltage having a plurality of voltage amplitude values is applied thereto. Corrected image data are calculated on the basis of the calculated correction values, and a drive signal is outputted to drive the electron emission devices on the basis of the corrected image data.

### BACKGROUND OF THE INVENTION

1. Field of the Invention

The present invention relates to an image display apparatus, a drive method for the image display apparatus, and a television set and, more particularly, to an image display apparatus having a plurality of electron emission devices and phosphors, a drive method for the image display apparatus, and a television set

2. Description of the Related Art

As panel types of self-luminous image display apparatuses, there are, for example, displays having pixels in each of which phosphors and microscopic electron emission devices are arranged, displays using electroluminescence, and displays in which a multiplicity of light-emitting diodes are arranged.

As an example which includes as electron emission devices a multiplicity of surface conduction electron emission devices (hereinafter referred to as the SCEs) arranged in a passive matrix form and is applied to an image display apparatus, there are U.S. Pat. No. 5,659,329 and JP-A-7-235255 filed by the present applicant. These publications disclose a construction and a drive method for the same. In the construction, a plurality of surface conduction electron emission devices are two-dimensionally arranged, each of which includes a pair of device electrodes provided on a substrate, an electrically conductive film connected to this pair of device electrodes, and an electron emitting section formed in the electrically conductive film, and electrical selecting means is disposed to individually select emission electrons emitted from each of the electron emission devices, so that an image is formed according to an input image signal by passive matrix driving.

In a multi-electron source made of a multiplicity of electron emission devices, a certain extent of nonuniformity occurs among the emission characteristics of the individual electron emission devices as the result of variations and the like in a manufacturing process.

Such a multi-electron source is suitable for the manufacture of a large-screen flat image display apparatus, but has a multiplicity of electron emission devices unlike CRTs. If an image display apparatus is manufactured with the multi-electron source, there occurs the problem that the nonuniformities of the characteristics of the individual electron emission devices appear as rough feeling (nonuniformity) of luminance. The reason why the electron emission characteristics of the multi-electron source differ among the individual electron sources is considered to be due to various causes such as the nonuniformity of ingredients of a material used for the electron emission section and the error of the dimension and shape of each member of the electron emission devices. However, if all these causes are to be eliminated, a very high degree of manufacturing equipment and very strict process control become necessary, but it is not realistic to satisfy all these demands, because huge manufacturing costs occur.

Phosphors used for a faceplate are generally formed as phosphor films respectively corresponding to individual pixels, by a printing method or a slurry method. However, if the phosphors are used for a large-screen image display apparatus, thickness irregularity may occur in the phosphors within the screen and cause irregularity in the emission efficiency of the same. This causes deterioration of the luminance uniformity of the screen. A metal back, which is generally used as means for improving emission efficiency, also causes irregularity in the reflectance of the screen and causes deterioration of the luminance uniformity of the screen.

For this reason, JP-A-2001-350442 attempts to solve the above-mentioned problem by obtaining correction values from measured luminance nonuniformity information, storing the correction values into a correction memory and correcting the amplitude or time width of a drive signal in accordance with the correction values. JP-A-2000-122598 attempts to provide a construction in which correction coefficients corresponding to the modulation level (gradation) of input image data are held for individual pixels so as to correct the modulation level and the uniformity of the screen. However, in this construction, it is necessary to store correction data for all pixels. If an image display apparatus of high resolution and high gradation resolution is constructed, the image display apparatus needs a storage device having a capacity of the number of pixels×the degree of gradation resolution. Accordingly, in a construction of, for example, 1,920×3×1,080×10 bits, even if correction arithmetic operation is performed with 8 bits, a storage capacity of 6.4 Gbytes is necessary, and the circuit scale becomes large. This is not realistic in terms of price.

A drive method will be described below. In the field of this kind of image display apparatus, a PWM (pulse width modulation) method and a PAM (pulse amplitude modulation) method are known as two major drive methods for controlling the luminance of image display elements.

The PWM method controls the luminance of an image display element by varying the pulse width (application time) of a drive voltage to be applied to the image display element. In the case of a typical image display element such as a cold-cathode electron emission device, since the electron emission amount linearly varies with the application time of drive voltage, the PWM method has the advantage of enabling easy luminance control, compared to the PAM method. However, the PWM method has the disadvantage that if the gradation of one element is to be increased with the PWM method, a reference clock (operating frequency) for pulse width modulation needs to be increased, so that increases in the cost and the power consumption of a drive circuit are incurred.

On the other hand, the PAM method controls of the luminance of an image display element by varying the amplitude (voltage value) of drive voltage. This method makes it possible to ensure gradation without increasing a reference clock frequency, but has the problem that electron emission devices generally exhibit nonlinear electron emission characteristics relative to voltage values and the amount of variation of emission electrons is large, so that stable luminance control of electron emission devices is difficult to carry out with the PAM method.

For this reason, it has recently been proposed to make an attempt to solve the problem of the PWM method by performing pulse width modulation using a plurality of drive voltages.

For example, JP-A-10-39825 discloses a method of decreasing the operating frequency of a driven circuit by using two kinds of drive voltages, a voltage V1 and a voltage V2. JP-A-7-181916 discloses a method of correcting the nonuniformity of each electron emission device by controlling both drive voltage and pulse width on the basis of luminance data and controls gradation by PWM and corrects the nonuniformity of each electron emission device by PAM.

In the case where the uniformity of the screen of an image display apparatus is improved by combining the above-described related arts so as to use PWM and PAM and by correcting the time axis of a drive signal, the following problem occurs.

Namely, the problem is that as display gradation is made smaller, the uniformity of the screen becomes lower.

In the following description, a local luminance nonuniformity a in the screen/an average value is used as an index indicative of the uniformity (where a is a standard deviation).

The case where the pulse width of each of the voltages V1 and V2 is controlled with 256 steps, i.e., a total of 512 modulation levels, will be described below.

Examples of modulated pulse waveforms outputted according to the respective modulation levels of a modulation signal will be described below with reference to FIG. 2. FIG. 2 shows conceptual diagrams of output pulse waveforms when the relationship between the voltages V1 and V2 for the modulation signal is V1<V2. The output pulse waveforms are divided into two major groups, and are determined, for example, as follows.

(a) Modulation Level of 1 to L1max

The output pulse waveform is a pulse of amplitude V1 whose pulse width varies according to the modulation level.

(b) Modulation Level of L1max+1 to L2max

The output pulse waveform is a pulse of amplitude V1 or a pulse of amplitude V2, and the pulse width of the pulse of amplitude V2 varies according to the modulation level.

FIG. 7 is a graph which shows uniformity appearing when driving is performed with this waveform and plots the modulation level on the horizontal axis and the uniformity (σ/average value) of a display area on the vertical axis.

The voltage levels to be used are switched therebetween at the 256th modulation level. Namely, in the above (a), L1max is set to 256, and in the above (b), L2max is set to 512. Accordingly, the range of the 1st to 256th modulation levels corresponds to the drive waveform shown in (a), while the range of the 257th to 512nd modulation levels corresponds to the drive waveform shown in (b).

As can be seen from FIG. 7, as the modulation level becomes lower, the uniformity becomes lower, and as the proportion in which lower voltage levels are mixed becomes larger, the uniformity becomes lower.

The reason why the uniformity varies according to the type of drive method is that in the case of an image display apparatus using phosphors, there exists a range in which the relationship between the emission characteristic and the strength of electron excitation is not linear.

FIG. 8 is a graph which plots element emission current on the horizontal axis and luminance on the vertical axis. In FIG. 8, points “×” indicate actually measured values, while a dashed line indicates a power approximation curve.

As can be seen from a comparison between the power approximation curve and the actually measured values, the slopes of both differ between a low emission current and a high emission current. Namely, in the case of luminance=(emission current)^{γ}, γ (gamma) has an emission current dependence.

From this fact, in the case where the nonuniformity of the emission characteristic of an electron source is observed as luminance, it is observed that the nonuniformity of the operating point of the electron source is large when the emission current is low, and when the emission current is large, the nonuniformity is small.

Accordingly, the phenomenon shown in FIG. 7 shows that when the drive voltage is low and the emission current is small, γ is large and the uniformity is low, whereas when the drive voltage is high and the emission current is large, the uniformity is relatively high.

In an intermediate gradation range in which the two kinds of operating voltages are used, the degree of mixture of emission sections each having different γ varies according to the temporal proportion of the voltages used. Accordingly, if the proportion of sections driven at high voltages is large, the uniformity is comparatively high, whereas if the proportion is small, the uniformity is comparatively low.

Since this characteristic exists, there occurs the problem that image quality becomes lower at lower modulation levels.

### SUMMARY OF THE INVENTION

The invention has been made to solve the above-described problems, and an object of the invention is to provide an image display apparatus in which a plurality of electron emission devices are arranged and which is capable of displaying a high-quality image by correcting and uniformizing the nonuniformity of electron emission characteristics, and the method thereof.

According to one aspect of the invention, there is provided an image display apparatus which includes electron emission devices respectively disposed on a substrate and phosphors which emit light when excited by electron beams emitted from the electron emission devices, and which is constructed to apply a pulse width modulated drive signal having a plurality of voltage amplitude values to the electron emission devices according to image data. The image display apparatus includes: storage means which stores correction values for correcting nonuniformities of luminance caused by the electron emission devices when a predetermined voltage is applied thereto; correction value calculation means which calculates correction values when the voltage having the plurality of voltage amplitude values is applied to the electron emission devices, by a predetermined arithmetic operation using the correction values when the predetermined voltage is applied; corrected image data calculation means which corrects the image data on the basis of an calculation result of the correction value calculation means and outputs corrected image data; and drive means which outputs the drive signal on the basis of the corrected image data.

According to the above aspect of the invention, the image display apparatus includes the storage means which stores correction values for correcting emission current nonuniformity information or luminance nonuniformity information on the plurality of electron emission devices when driving on one certain operating condition, for example, driving at a constant voltage, is performed. Accordingly, in the case where the emission current nonuniformity information on the plurality of electron emission devices is stored, only the characteristic nonuniformity of the electron emission devices is corrected, whereas in the case where the luminance nonuniformity information is stored, emission nonuniformity caused by a faceplate owing to the thickness irregularity of phosphors and the reflectance irregularity of a metal back can be corrected.

According to the above aspect of the invention, the image display apparatus includes the correction value calculation means which calculates the correction values when a plurality of voltage amplitude values are applied to the electron emission devices. This means calculates correction values when a plurality of voltage amplitude values are applied and a plurality of drive conditions are combined.

As a calculation method, for example, the ratio of a nonuniformity amount under drive conditions based on stored correction values to a nonuniformity amount under conditions calculated is held, and during driving, correction values are multiplied by the ratio according to conditions. Accordingly, it is possible to find correction values for different drive conditions.

As another calculation method, data on the emission current dependence of γ which represent the relationship between emission current and luminance are held as a function, and coefficients corresponding to stored correction values are calculated according to drive conditions, and the correction values are multiplied by the coefficients.

Since the image display apparatus is driven by the drive means according to the corrected image data, the uniformity of the image display apparatus can be made high and further can be prevented from varying, even when gradation (grayscale) is varied.

According to another aspect of the invention, the image display apparatus further includes drive time holding means which holds a drive time in order to vary the calculation content of these correction values according to variations with age. This means makes it possible to correct the influence of variations with age on gamma. The drive time holding means may hold a drive time (injected charge amount) for each pixel, and can perform highly accurate correction irrespective of displayed images by varying the calculation content of correction values according to the variations with age of gamma of luminance with respect to emission current.

In the case where the image display apparatus is used in an application which provides display of an image which does not show specific distribution in the screen when temporally averaged over a long time of viewing of a general received TV image or the like, the drive time holding means does not need to hold the drive time of each pixel, and may also hold the average drive time of all pixels.

According to the invention, it is possible to provide high-quality image display by correcting and uniformizing the nonuniformity of electron emission characteristics in an image display apparatus in which a plurality of electron emission devices are arranged.

### BRIEF DESCRIPTION OF THE DRAWINGS

FIG. 1 is a schematic block diagram for explaining an image display apparatus according to a preferred embodiment of the invention;

FIG. 2 is a schematic view for explaining pulse shapes which are used in a modulation method made of a combination of a plurality of amplitude levels and a plurality of pulse widths according to the preferred embodiment of the invention;

FIG. 3 is a modulation-level (gradation) dependence graph of gain to be multiplied by correction table values used in the preferred embodiment of the invention;

FIGS. 4A to 4B are explanatory views of details of correction used in the preferred embodiment of the invention;

FIG. 5 is a contour map showing one example of emission current distribution of an SCE;

FIG. 6 is a current-density dependence graph of the degree of deterioration of a phosphor;

FIG. 7 is a graph showing the relationship between input image luminance and output modulated pulse width which are associated with each other on the basis of a conversion table used in the preferred embodiment of the invention;

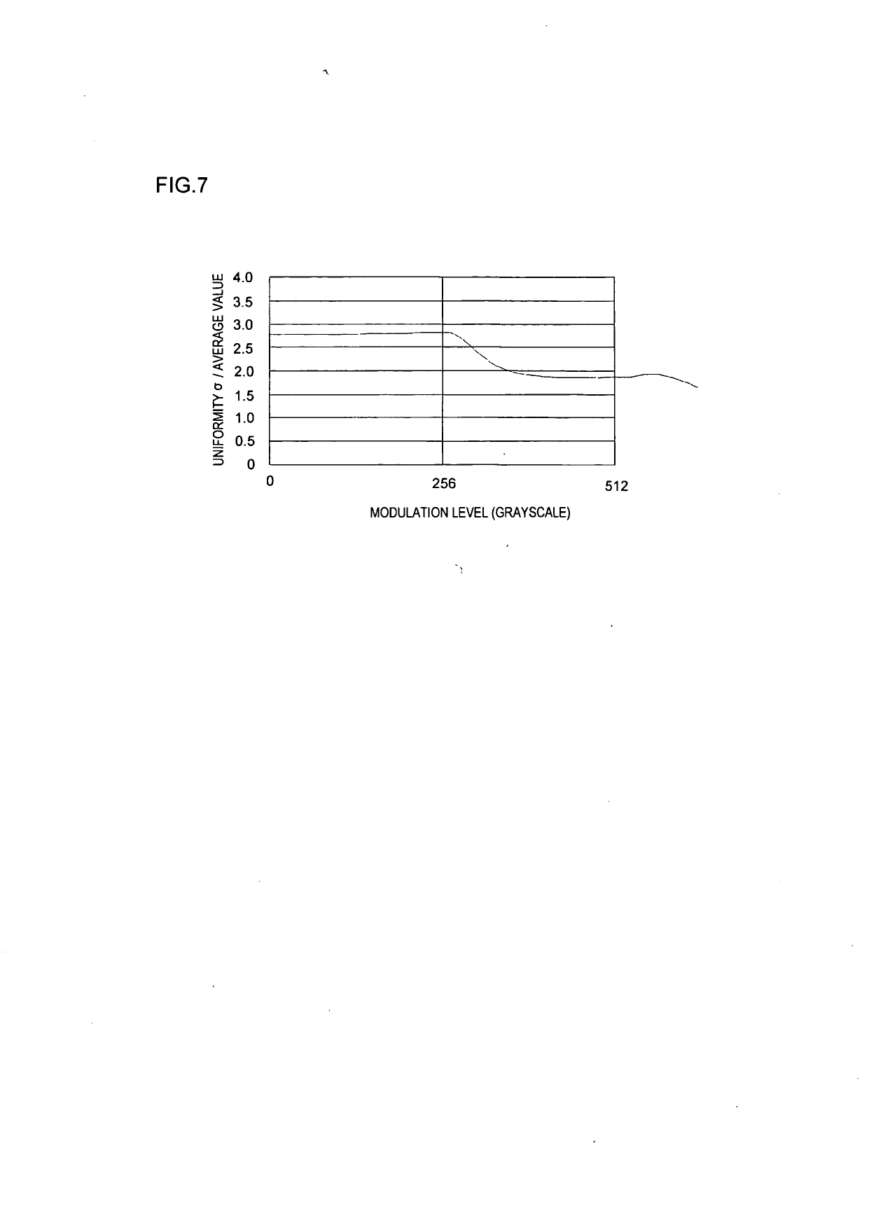

FIG. 8 is a graph of the dependence of luminance on emission current; and

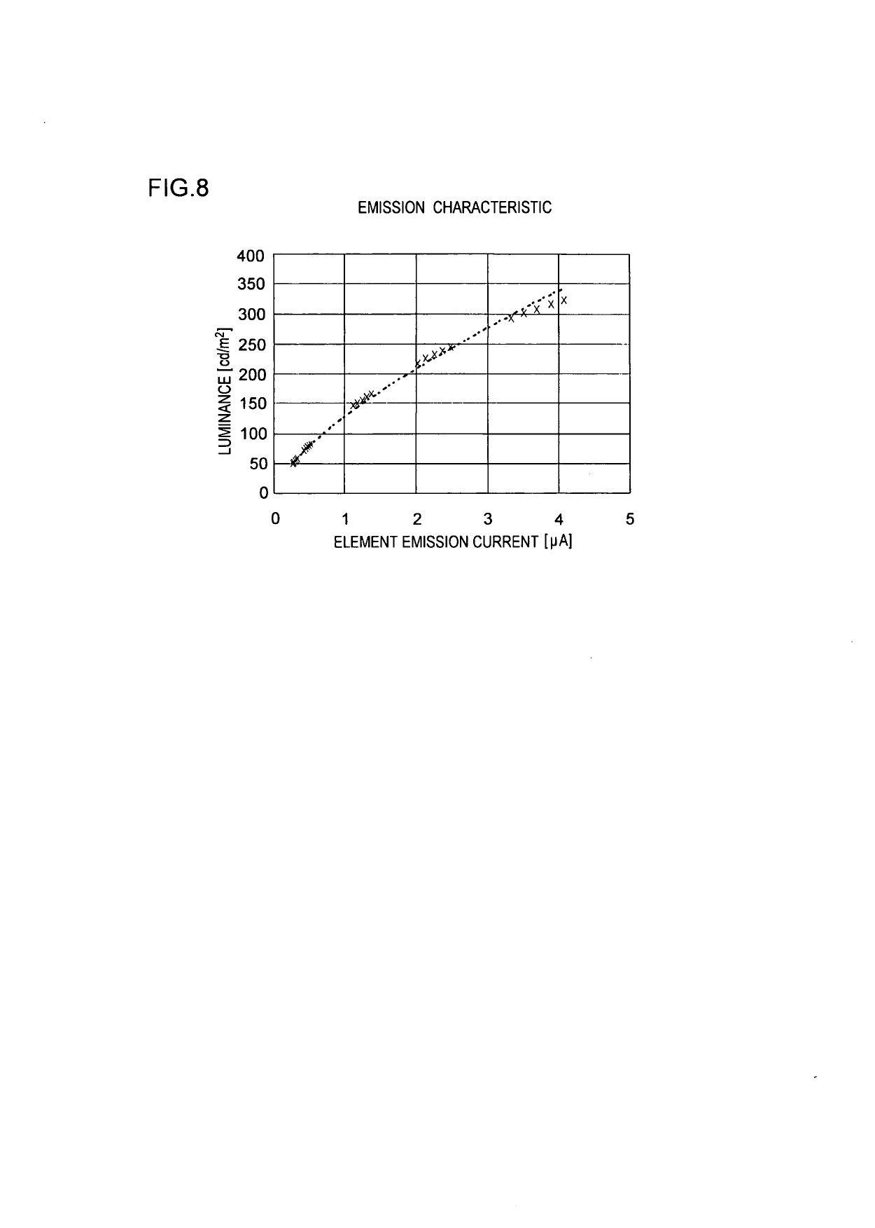

FIG. 9 is a block diagram of a television set according to the preferred embodiment of the invention.

### DETAILED DESCRIPTION OF THE PREFERRED EMBODIMENT

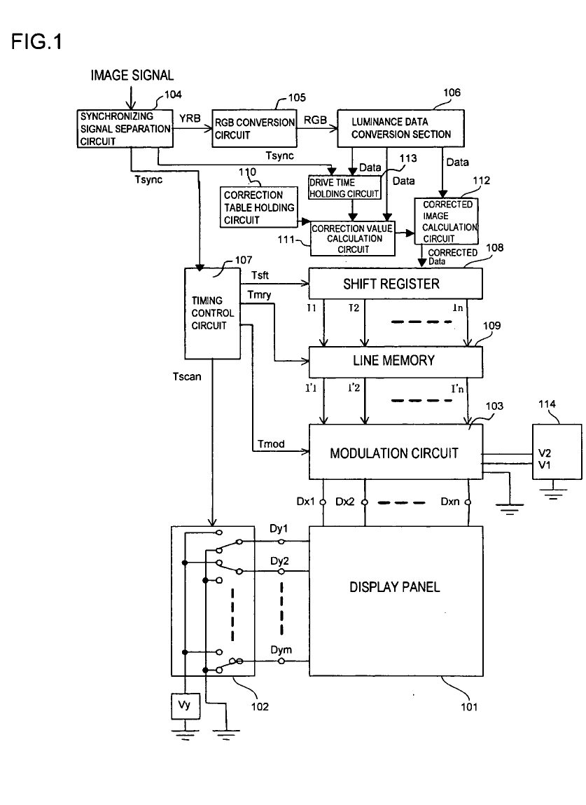

An image display apparatus according to a preferred embodiment of the invention will be described below with reference to FIG. 1.

FIG. 1 is a schematic block diagram showing one example of a circuit construction which realizes the image display apparatus according to the preferred embodiment of the invention as well as a driving method for the same.

(Entire Construction of Image Display Apparatus)

The image display apparatus shown in FIG. 1 includes a display panel 101 having a plurality of image forming elements arranged in the form of a passive matrix wiring, terminals Dy1 to Dym to which row wirings of the display panel 101 are respective connected, terminals Dx1 to Dxm to which column wirings of the display panel 101 are respectively connected, a scanning circuit 102, a modulation circuit 103, a synchronizing signal separation circuit 104, a RGB conversion circuit 105 which converts to RGB signals YRB signals received from the synchronizing signal separation circuit 104, a luminance data conversion section 106 which converts luminance information on each of the RGB color signals to a modulation depth, a timing control circuit 107, a shift register 108 having a storage capacity for one line of image data, a line memory 109 having a storage capacity for one line of image data, a correction table holding circuit 110 made of a nonvolatile memory, a correction value calculation circuit 111, a corrected image calculation circuit 112, and a drive time holding circuit 113.

In the case where the image forming elements are constructed to emit light by using cathode luminescence, a high voltage power source (not shown) for accelerating emission electrons is connected to a high voltage terminal (not shown) of the display panel 101.

(Synchronizing Signal Separation Circuit and Timing Control Circuit)

When an image signal is inputted to the image display apparatus, a synchronizing signal Tsync (including a vertical synchronizing signals and a horizontal synchronizing signal) is supplied to the timing control circuit 107 by the synchronizing signal separation circuit 104. Video signals YRB are converted to digital RGB signals indicative of image data by the RGB conversion circuit 105, and the digital RGB signals are supplied to the luminance data conversion section 106.

The luminance data conversion section 106 performs inverse γ correction and adjustment of desired color balance on broadcasting waves for each of the RGB input values, and then, outputs modulation level data to be used for correction value arithmetic operation and corrected-image generation.

The timing control circuit 107 determines the operation timing of each section in synchronism with the synchronizing signal Tsync of the video source. Namely, the timing control circuit 107 generates signals such as a signal Tsft for controlling the operation timing of the shift register 108, a signal Tmry for controlling the operation timing of the line memory 109, a signal Tmod for controlling the operation timing of the modulation circuit 103, and a signal Tscan for controlling the operation timing of the scanning circuit 102.

(Correction Table Holding Circuit, Correction Value Calculation Circuit, Drive Time Holding Circuit, and Corrected Image Calculation Circuit)

The correction table holding circuit 110 holds a correction table value expressed by a fraction whose numerator indicates a minimum value in the screen of the image display apparatus and whose denominator indicates the normalized value of luminance values at all points on the screen of the image display apparatus at a certain level of drive voltage. The correction value calculation circuit 111 calculates a correction coefficient corresponding to gradation (grayscale) levels at all points by adjusting gain according to a modulation level with respect to the correction table value.

This gain is modified on the basis of the cumulative drive time of each pixel which is held in the drive time holding circuit 113.

The drive time holding circuit 113 holds values respectively obtained by integrating modulation level data for individual pixels each time the drive time holding circuit 113 receives the synchronizing signal Tsync from the synchronizing signal separation circuit 104. The corrected image calculation circuit 112 multiplies the modulation level by the correction coefficient and generates corrected image data.

(Scanning Circuit)

The scanning circuit 102 is a circuit which outputs a selection voltage Vy or a non-selection voltage (for example, 0 V) to the connection terminals Dy1 to Dym in order to sequentially scan the display panel 101 on a line-by-line basis, and contains m number of switches. These switches are preferably made of transistors or FETs.

The value of the selection voltage Vy to be outputted from the scanning circuit 102 and the value of a modulation signal which will be described later may be determined on the basis of the luminance vs. drive voltage characteristic of image display elements to be used.

(Shift Register, Line Memory, and Modulation Circuit)

The corrected image data generated by the corrected image calculation circuit 112 is converted from serial to parallel format by the shift register 108, and the resultant corrected image data is stored in the line memory 109 for one horizontal scanning period. On the basis of corrected image data I′1 to I′n stored in the line memory 109, the modulation circuit 103 outputs pulse width modulated drive waveforms having a plurality of voltage amplitude values to the corresponding column wiring terminals Dx1 to Dxn of the display panel 101.

(Operation of Image Display Apparatus)

The operation of the image display apparatus having the above-described construction will be described below in further detail with reference to FIG. 1.

The image display apparatus shown in FIG. 1 uses a pulse width modulation method having a plurality of voltage amplitude values prepared for the modulation circuit 103.

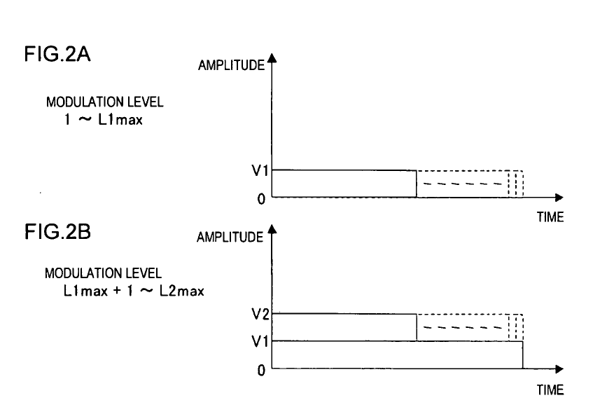

The modulation circuit 103 outputs modulated pulses each made of any one of a plurality of amplitude levels and any one of a plurality of pulse widths in response to the modulation level signals I′1 to I′n transmitted from the line memory 109. For example, if a combination of two amplitude levels is used, two source voltages V1 and V2 are used in a power source 114 for the modulation signal. Examples of modulated pulse waveforms which are respectively outputted from the modulation circuit 103 in accordance with different modulation levels of the modulation signal will be described with reference FIG. 2. FIG. 2 shows conceptual diagrams of pulse waveforms outputted from the modulation circuit 103 when the relationship between the voltages V1 and V2 of the modulation signal power source 114 is V1<V2. The output pulse waveforms are divided into two major groups, and are determined, for example, as follows.

(a) Modulation Level of 1 to Limax

The output pulse waveform is a pulse of amplitude V1 whose pulse width varies according to the modulation level.

(b) Modulation Level of L1max+1 to L2max

The output pulse waveform is a pulse of amplitude V1 or a pulse of amplitude V2, and the pulse width of the pulse of amplitude V2 varies according to the modulation level.

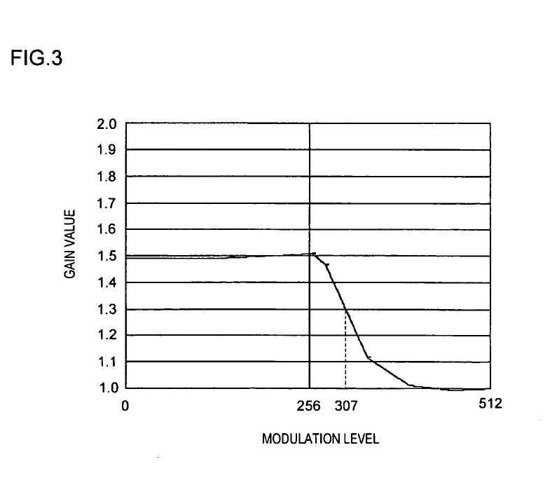

The rate of increase of nonuniformity data due to gradation variations (gradation level variations) when the display panel 101 is driven by these drive waveforms is found as gain, and the correction table value is multiplied by the gain. The resultant gain value is shown in the graph of FIG. 3.

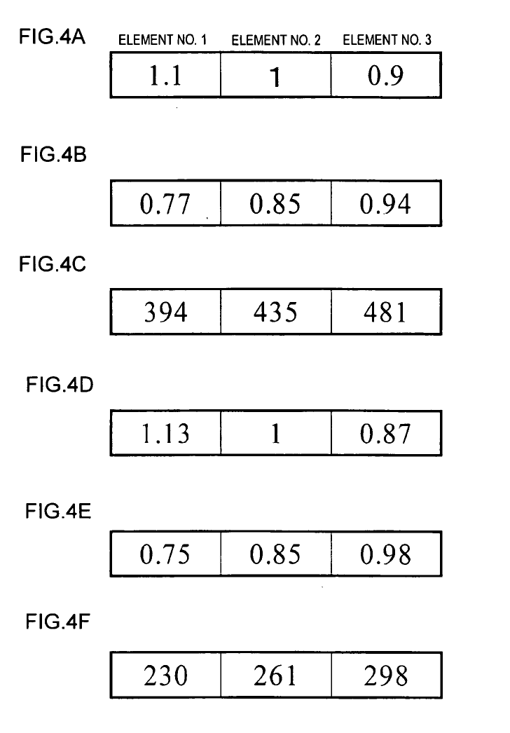

Details will be described below. FIG. 4A shows normalized luminance distribution data on three elements No. 1, No. 2 and No. 3 which give representative normalized luminance distribution data when drive pulses of voltage level V2 and maximum pulse width (the same pulse width) are applied to the display panel 101. For the purpose of illustration, a location which exhibits a maximum value in the screen is selected as the element No. 1, a location which exhibits an average value in the screen is selected as the element No. 2, and a location which exhibits a minimum value in the screen is selected as the element No. 3.

FIG. 4B shows correction values which are written to the correction table holding circuit 110 so that an image can be uniformly displayed with respect to these data.

These correction values are selected on the assumption that corrected values provide an average decrease in luminance of 15% compared to the uncorrected normalized data so that an image is uniformly displayed at a luminance level of 0.85. Namely, a calculation expressed by 0.85÷the normalized data is performed. In the case of this modulation level, the target luminance level after correction may also be 0.9 with respect to the normalized data before correction. However, since the amount of nonuniformity is 1.5 times as large in the range of low modulation levels as shown in FIG. 3, 0.85 which results from a decrease in luminance of 0.15 is made a target luminance value.

If image data having a modulation level of 512 is inputted to each of the three elements, the correction value calculation circuit 111 outputs correction coefficients obtained by multiplying the correction values by a gain of 1, on the basis of the data shown in FIG. 3.

The output from the corrected image calculation circuit 112 is values obtained by multiplying the input indicated value of 512 by the correction coefficients, as shown in FIG. 4C.

If image data having a modulation level of 307 is inputted to each of the three elements, the correction value calculation circuit 111 calculates correction coefficients by using a gain of 1.3 on the basis of the data shown in FIG. 3.

Since luminance values predictable at this time are those shown in FIG. 4D which are obtained by multiplying nonuniformity values by 1.3 and adding 1 to the products, the calculated correction coefficients are as shown in FIG. 4E. The values shown in FIG. 4D are given by the following expression:
the values of FIG. 4D=(the values of FIG. 4A—1)×1.3+1.

The output from the corrected image calculation circuit 112 is values obtained by multiplying an input indicated value of 307 by the correction coefficients, as shown in FIG. 4F.

Even when the modulation level takes on a different value or differs for each pixel, similar arithmetic operations are performed to generate corrected image and drive the display panel 101, thereby enabling uniform correction.

The gain, shown in FIG. 3, based on the modulation level for correction is corrected by the correction value calculation circuit 111 on the basis of the drive time of each pixel which is held in the drive time holding circuit 113.

In the first embodiment, the reason why the image display apparatus is constructed so that the gain is corrected on the basis of the drive time of each pixel is that the gamma of luminance relative to emission current that is to be corrected according to drive conditions also varies according to not only drive conditions but also deterioration with age.

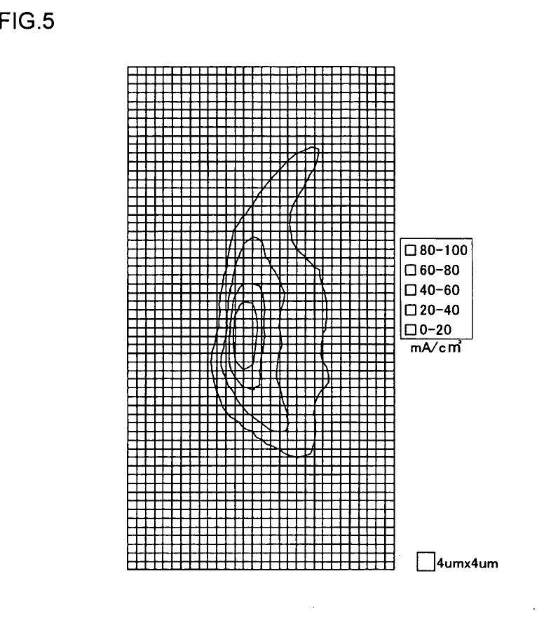

FIG. 5 is a contour map showing one example of emission current distribution of an SCE.

As shown in FIG. 5, in the case where phosphors and electron sources each having a nonuniform emission current distribution are combined to constitute an image display device, the following problem occurs.

In general, the emission efficiency of a phosphor deteriorates according to the amount of charge injected into the phosphor during excitation thereof. Accordingly, the degree of deterioration of the phosphor differs between a location where current density is high and a location where current density is low, according to the state of current distribution.

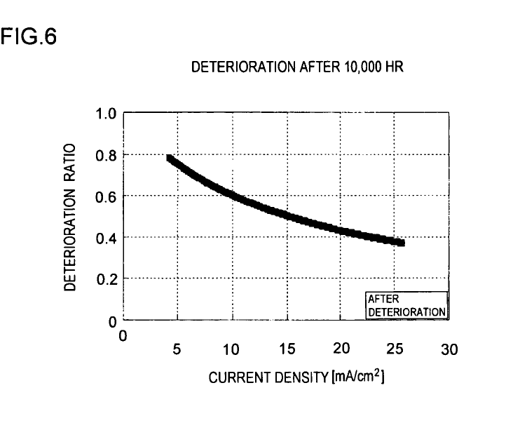

FIG. 6 shows the degree of deterioration of a phosphor driven by an SCE for 10,000 hours, which phosphor has the characteristic that its emission efficiency decreases to half on the condition of average 20 mA/cm², and has an injected charge amount of 150 Coulombs/cm². This graph plots current density on the horizontal axis and degree of deterioration on the vertical axis, and shows the degree of deterioration of the phosphor after 10,000 hours. When the image display apparatus is used for a long time, the distribution of deterioration occurs. The luminance of the pixel is an integration value and largely contributes to the emission of a section of low current density, so that the gamma of the luminance of the pixel with respect to emission current becomes large.

As mentioned above, the gamma of luminance relative to emission current that is to be corrected according to drive conditions also varies according to not only drive conditions but also deterioration with age.

The variations of γ due to the deterioration with age of image display apparatuses fabricated on the same conditions were approximately 2% after the passage of 15,000 hours. For this reason, the correction value calculation circuit 111 is set to linearly approximate the variation of the gamma of the luminance of each pixel in accordance with a slope which varies by 2% per 15,000 hours, according to the drive time of each pixel held in the drive time holding circuit 113, and perform the above-mentioned arithmetic operation every 2,500 hours by using correction values obtained by multiplying the gain values shown in FIG. 3 by correction values for the deterioration with age.

The drive time holding circuit 113 holds values obtained by integrating modulation amount data for each pixel in accordance with each synchronizing signal Tsync transmitted from the synchronizing signal separation circuit 104. The corrected image calculation circuit 112 multiplies the modulation level data by the correction coefficients and generates corrected image data.

In the preferred embodiment, two kinds of modulation voltages V1 and V2 are used, but it is apparent that the number of kinds of modulation voltages is not limitative and can also be made larger. In addition, although the variation of gain due to deterioration with age is corrected by the correction value calculation circuit 111, a volatile (rewritable) circuit may be used as the correction table holding circuit 110 to periodically rewrite the correction table value so as to correct the variation of gain due to deterioration with age. In general, an inexpensive and high-speed nonvolatile (nonrewritable) memory seems to be obtainable, but it is not limitative.

Accordingly, according to the preferred embodiment, it is possible to obtain an image display apparatus which is constructed to use a combination of amplitude modulation using a plurality of voltage values and pulse width modulation and in which good uniformity can be obtained, but can be prevented from being varied even if gradation is changed or deterioration with age proceeds.

In addition, since correction data corresponding to the gradation of each pixel need not be held in the image display apparatus, the image display apparatus according to the preferred embodiment can be inexpensively constructed.

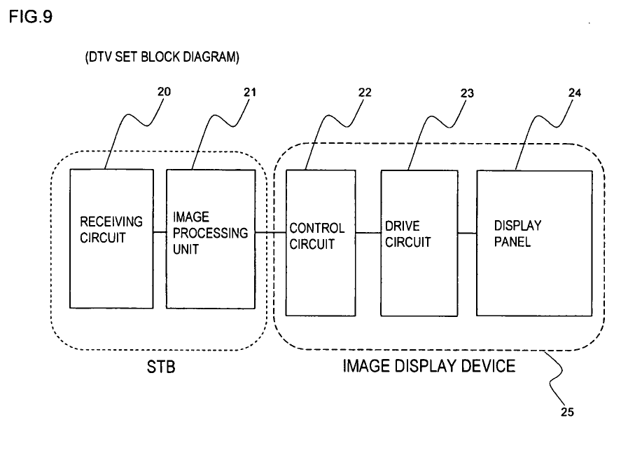

FIG. 9 is a block diagram of a television set according to the preferred embodiment of the invention. A receiving circuit 20 includes a tuner, a decoder and the like, and receives television signals such as ground waves and satellite broadcasting waves or data broadcasting via a network and outputs decoded video data to an image processing unit 21. The image processing unit 21 includes a γ correction circuit, a resolution conversion circuit and an I/F circuit as well as the video signal correction device mentioned in the above description of the preferred embodiment, and converts the image-processed image data to a display format for an image display device 25 and outputs the resultant image data to the image display device 25. The image display device 25 includes a display panel 24, a drive circuit 23 and a control circuit 22. The control circuit 22 applies signal processing such as correction processing suitable for the display panel 24 to the input image data, and outputs the resultant image data and various control signals to the drive circuit 23. The drive circuit 23, on the basis of the input image data, outputs drive signals to the display panel 24 and causes the display panel 24 to display a television picture. The receiving circuit 20 and the image processing unit 21 may be housed in a casing different from the display device 25 as a set top box (STB26), and may also be housed in a casing integral with the display device 25.

This application claims priority from Japanese Patent Application No. 2004-66103 filed Mar. 9, 2004, which is hereby incorporated by reference herein.

1. An image display apparatus which includes electron emission devices respectively disposed on a substrate and phosphors which emit light when excited by electron beams emitted from the electron emission devices, and is constructed to apply a pulse width modulated drive signal having a plurality of voltage amplitude values to the electron emission devices according to image data,
the image display apparatus comprising:
storage means which stores correction values for correcting nonuniformities of luminance caused by the electron emission devices when a predetermined voltage is applied thereto;
correction value calculation means which calculates correction values when the voltage having the plurality of voltage amplitude values is applied to the electron emission devices, by a predetermined arithmetic operation using the correction values when the predetermined voltage is applied;
corrected image data calculation means which corrects the image data on the basis of an calculation result of the correction value calculation means and outputs corrected image data; and
drive means which outputs the drive signal on the basis of the corrected image data.

2. An image display apparatus according to claim 1, wherein the predetermined arithmetic operation is an arithmetic operation which multiplies the correction values for correcting the nonuniformities of luminance caused by the electron emission devices when the predetermined voltage is applied thereto, by a gain corresponding to a modulation level.

3. An image display apparatus according to claim 2, further comprising drive time holding means which stores cumulative drive time of each of the electron emission devices, the image display apparatus being operative to vary the gain according to the drive time stored in the drive time holding means.

4. An image display apparatus according to claim 2, wherein the predetermined voltage is approximately coincident with a maximum amplitude value from among the plurality of voltage amplitude values.

5. An image display apparatus according to claim 2, wherein the correction values for correcting the nonuniformities of luminance caused by the electron emission devices when the predetermined voltage is applied thereto are calculated on the basis of nonuniformities of luminance caused by the electron emission devices with respect to a predetermined target luminance value.

6. An image drive method for an image display apparatus constructed to apply a pulse width modulated drive signal having a plurality of voltage amplitude values to electron emission devices according to image data and cause phosphors to emit light by electron beams emitted from the electron emission devices, comprising the steps of:
calculating correction values when a voltage having the plurality of voltage amplitude values is applied to the electron emission devices, by a predetermined arithmetic operation using correction values for correcting nonuniformities of luminance caused by the electron emission devices when a predetermined voltage is applied thereto;
calculating corrected image data on the basis of the calculated correction values; and
outputting the driving signal and driving the electron emission devices, on the basis of the corrected image data.

7. A drive method for the image display apparatus according to claim 6, wherein the predetermined arithmetic operation is an arithmetic operation which multiplies the correction values for correcting the nonuniformities of luminance caused by the electron emission devices when the predetermined voltage is applied thereto, by a gain corresponding to a modulation level.

8. A television set comprising:
a receiving circuit which receives a television signal and outputs an input luminance signal to an image processing unit; and
an image display apparatus according to claim 1, which displays a video image on the basis of image data outputted from the image processing unit.
